(19) United States
(12) Patent Application Publication
(10) Pub. No.: US 2011/0210172 A1
(43) Pub. Date: Sep. 1, 2011

(54) MAGNETIC CARD READER APPARATUS

(75) Inventors: Atsushi Kobayashi, Inagi (JP); Hideki Fukushi, Inagi (JP); Ichiro Yamamoto, Inagi (JP); Yoshikazu Kawamoto, Inagi (JP); Yoshihito Kouda, Inagi (JP); Taisuke Hattori, Inagi (JP); Katsutoshi Matsuura, Inagi (JP)

(73) Assignee: FUJITSU FRONTECH LIMITED, Tokyo (JP)

(21) Appl. No.: 13/031,443

(22) Filed: Feb. 21, 2011

(30) Foreign Application Priority Data
Feb. 26, 2010 (JP) 2010-042716

(51) Int. Cl. G06K 7/08; G06K 7/01

(52) U.S. Cl. 235/449

(57) ABSTRACT

A magnetic card reader apparatus includes a magnetic data reading unit configured to read magnetic data of a magnetic card, an insertion detecting unit configured to detect an insertion of the magnetic card, and an interval increase/decrease driving unit configured to increase/decrease an interval between the magnetic data reading unit and the magnetic card when the insertion detecting unit detects the insertion of the magnetic card.

### CROSS-REFERENCE TO RELATED APPLICATION

This application is based upon and claims the benefit of priority of prior Japanese Patent Application No. 2010-042716, filed on Feb. 26, 2010, the entire contents of which are incorporated herein by reference.

### FIELD

The present invention relates to a magnetic card reader apparatus for reading magnetic data of a magnetic card.

### BACKGROUND

In recent years, the number of failures in reading a magnetic card has been increasing. Read failures are produced by a magnetic force decrease (demagnetization) caused by bringing a magnet (such as a cellular phone or the like) close to a magnetic card and by magnetic data distortion (noise) caused when magnetic data is written.

A structure for pushing a magnetic head up along with a protrusion by pushing the protrusion up within a grooved guide of a magnetic card in order to reduce the shock to the magnetic head and to stabilize a head touch is known as a structure for reading magnetic data of a magnetic card (for example, see Patent Document 1).

A ticket handling apparatus for detecting a thickness of a ticket and for changing a magnetic field intensity applied to read magnetic data based on a detection result in order to prevent a magnetic face of a magnetic card from being demagnetized by an external magnetic field of a magnetic sensor is also known (for example, see Patent document 2).

In the meantime, to cope with a magnetic force decrease (demagnetization) that produces the above described read failures, it is necessary to improve the sensitivity of a data read made by a magnetic head. Moreover, to cope with magnetic data distort (noise) that also produces the above described read failures, it is necessary to reduce the sensitivity of a data read made by a magnetic head.

Accordingly, a technique for enabling both a demagnetized magnetic card and a data-distorted magnetic card to be read up to a certain level by setting a constant of a read circuit to a suitable value is adopted. However, such a read method does not offer optimum measures against both demagnetized and data-distorted magnetic cards, leading to difficulty in preventing a failure in reading a magnetic card from occurring.

### Patent Document 1:

Japanese Laid-open Patent Publication No. H10-143975

### Patent Document 2:

Japanese Laid-open Patent Publication No. H05-94667

### SUMMARY

An object of the present invention is to provide a magnetic card reader apparatus able to prevent a failure in reading a magnetic card from occurring with a simple configuration.

A magnetic card reader apparatus according to the present invention includes a magnetic data reading unit configured to read magnetic data of a magnetic card, an insertion detecting unit configured to detect an insertion of the magnetic card, and an interval increase/decrease driving unit configured to increase/decrease an interval between the magnetic data reading unit and the magnetic card when the insertion detecting unit detects the insertion of the magnetic card.

According to the present invention, it becomes possible to prevent a failure in reading a magnetic card from occurring with a simple configuration.

### BRIEF DESCRIPTION OF DRAWINGS

FIG. 1 is a perspective top view (No. 1) illustrating an internal structure of a magnetic card reader apparatus according to an embodiment of the present invention;

FIG. 2 is a perspective top view (No. 2) illustrating the internal structure of the magnetic card reader apparatus according to the embodiment of the present invention;

FIG. 3 is a side view illustrating the right side of the magnetic card reader apparatus according to the embodiment of the present invention;

FIG. 4 is a perspective top view illustrating an internal structure of a magnetic card reader apparatus according to a modification example of the embodiment of the present invention;

FIG. 5 is a perspective top view (No. 1) illustrating an internal structure of a magnetic card reader apparatus according to a different embodiment of the present invention;

FIG. 6 is a perspective top view (No. 2) illustrating the internal structure of the magnetic card reader apparatus according to the different embodiment of the present invention;

FIG. 7 is a perspective top view illustrating an internal structure of a magnetic card reader apparatus according to a first modification example of the different embodiment of the present invention; and

FIG. 8 is a perspective top view illustrating an internal structure of a magnetic card reader apparatus according to a second modification example of the different embodiment of the present invention.

### DESCRIPTION OF EMBODIMENTS

Magnetic card reader apparatuses according to embodiments of the present invention are described below with reference to the drawings.

### One Embodiment

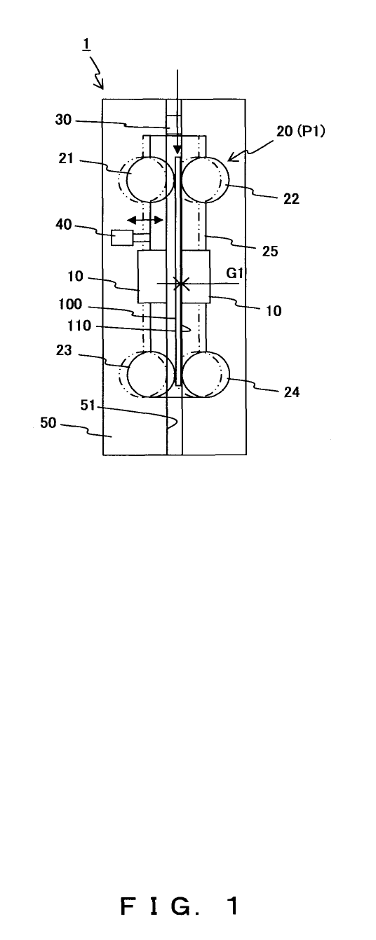

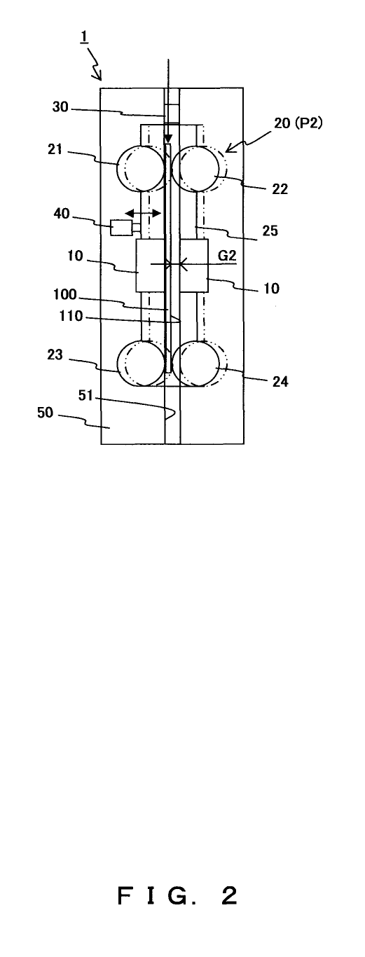

FIGS. 1 and 2 are perspective top views illustrating an internal structure of a magnetic card reader apparatus 1 according to an embodiment of the present invention.

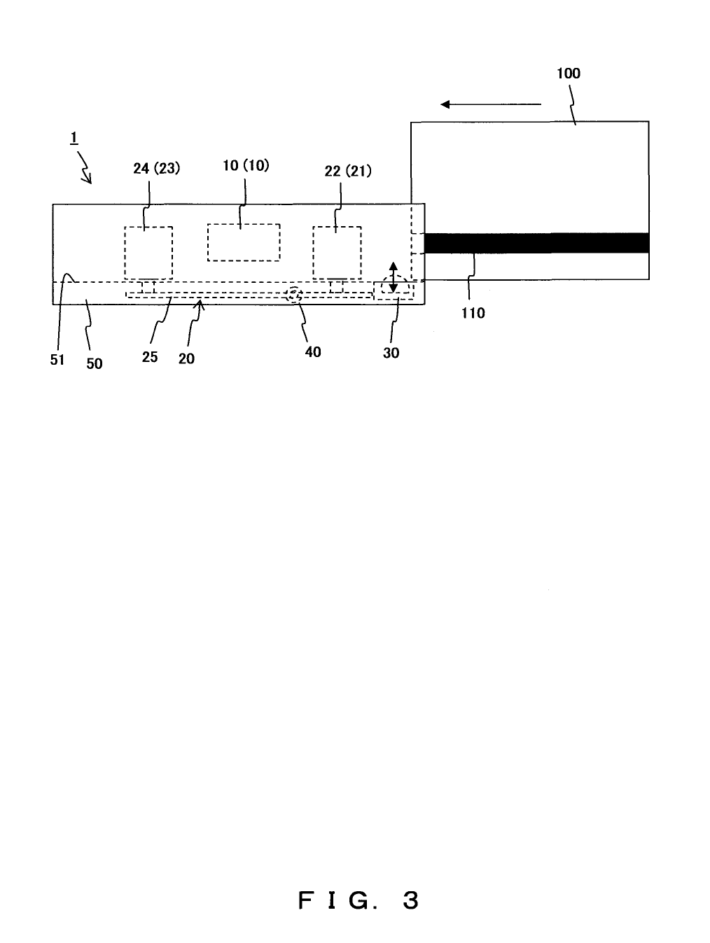

FIG. 3 is a side view of the magnetic card reader apparatus 1.

The magnetic card reader apparatus 1 illustrated in FIGS. 1 to 3 includes two magnetic heads 10 and 10 as magnetic data reading units, a card guide unit 20, an insertion detecting unit 30, a guide unit driving unit 40 as an interval increase/decrease driving unit, and housing 50.

As illustrated in FIGS. 1 to 3, the two magnetic heads 10 and 10 are arranged within the housing 50, and they read magnetic data of a magnetic card 100 inserted in a slit 51 that is provided on an upper surface of the housing 50. The slit 51 is a magnetic data read groove in which the magnetic card 100 is inserted. The slit 51 is extends from the top to the bottom of FIGS. 1 and 2.

The two magnetic heads 10 and 10 are arranged to face each other with the slit 51 interposed. If the two magnetic heads 10 and 10 are arranged in this way, magnetic data can be read from a magnetic stripe 110, illustrated in FIG. 3, of the magnetic card 100 regardless of the orientations of the right and the back sides of the magnetic card 100 when the magnetic card 100 is inserted. Accordingly, if the orientations of the right and the back sides of the magnetic card 100 are limited to either of the orientations when the magnetic card 100 is inserted, only one magnetic head 10 may be arranged.

The card guide unit 20 includes four guide members 21, 22, 23 and 24, and a plate 25 as a support member for supporting the guide members 21 to 24. The card guide unit 20 is arranged within the housing 50.

The guide members 21 to 24 include the guide members 21 and 22 that face each other with the slit 51 interposed on the entry side (the upper side of FIGS. 1 and 2) of the slit 51, above the magnetic heads 10 and 10 in the orientation of FIGS. 1 and 2, and the guide members 23 and 24 that face each other with the slit 51 interposed on the exit side (the lower side of FIGS. 1 and 2) of the slit 51, below the magnetic heads 10 and 10 in the orientation of FIGS. 1 and 2.

The plate 25 is arranged below the bottom of the slit 51. The guide members 21 to 24 are, for example, rollers each having an axis supported on the surface of the plate 25 and which are rotatable about a rotational axis that extends in a vertical direction. The plate 25 guides the magnetic card 100 inserted in the slit 51.

The guide members 21 to 24 in this embodiment are arranged in pairs so that the respectively paired members face each other. Therefore, it is possible to securely define an insertion route of the magnetic card 100. The insertion route of the magnetic card 100 passes through the right edge of the slit 51 in the example illustrated in FIG. 1, and passes through the left edge of the slit 51 in the example illustrated in FIG. 2.

The insertion detecting unit 30 is arranged within the housing 50 so that it protrudes from the bottom on the entry side of the slit 51. The insertion detecting unit 30 is, for example, a mechanical switch. The insertion detecting unit 30 is a contact-type detecting unit configured to detect an insertion of the magnetic card 100 by being pressed down as a result of making contact with the magnetic card 100 when the magnetic card 100 is inserted.

The guide unit driving unit 40 is, for example, a solenoid and a plunger. The guide unit driving unit 40 is arranged within the housing 50.

The guide unit driving unit 40 moves the card guide unit 20 by pushing/pulling the plate 25, for example with the solenoid via the plunger when the insertion detecting unit 30 detects the insertion of the magnetic card 100. The guide unit driving unit 40 moves the card guide unit 20 between a first position P1 (see FIG. 1) and a second position P2 (see FIG. 2), at which intervals (G1, G2) between the magnetic head 10 and the magnetic card 100 are different from each other, each time the insertion of the magnetic card 100 is detected.

Since the magnetic stripe 110 of the magnetic card 100 is formed on the right side in FIG. 1, the interval G1 between the magnetic head 10 on the right side and the magnetic card 100 when the card guide unit 20 stays at the first position P1 as illustrated with a solid line in FIG. 1 is narrower than the interval G2 when the card guide unit 20 stays at the second position P2 illustrated with a solid line (double dotted dashed line in FIG. 1) in FIG. 2.

In contrast, if the magnetic stripe 110 of the magnetic card 10 are formed on the left side in FIG. 1, the interval (not illustrated) between the magnetic head 10 and the magnetic card 100 when the card guide unit 20 stays at the second position P2 is narrower than the interval when the card guide unit 20 stays at the first position P1.

The card guide unit 20 may be moved in a direction of increasing/decreasing the interval between the magnetic head 10 and the magnetic card 100. Therefore, the guide driving unit 40 may be configured to move the card guide unit 20 between three or more positions.

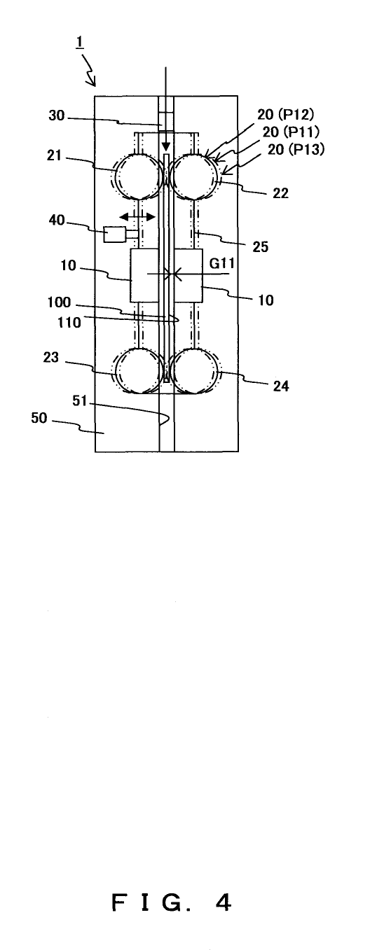

Additionally, as illustrated in FIG. 4 (as a modification example of this embodiment), the card guide unit 20 may be moved from a reference position P11 to either a position P12 at which an interval (G11) between the magnetic head 10 and the magnetic card 100 is wider than that at the reference position P 11 or a position P13 at which the interval is narrow when the insertion detecting unit 30 detects the insertion of the magnetic card 100, or the card guide unit 20 may be moved to the other position (position P13 or P12) when the next insertion of the magnetic card 100 is detected.

In this case, a controlling unit may control the guide unit driving unit 40 to restore the card guide unit 20 to the reference position P11 when the insertion of the magnetic card 100 is detected after a predetermined amount of time elapses from the detection of the preceding insertion of the magnetic card 100. Alternatively, a control for restoring the card guide unit 20 to the reference position P11 based on a timer circuit or the like after a predetermined amount of time elapses from the detection of the preceding insertion of the magnetic card 100, and for canceling a moving of the card guide unit 20 even if the next insertion of the magnetic card 100 is detected, may be performed. As described above, it is preferable to perform a control for enabling the magnetic card 100, inserted after a predetermined amount of time elapses from the detection of the preceding insertion of the magnetic card 100, to be guided by the card guide unit 20 that stays at the reference position P11.

In the above described embodiment, the guide unit driving unit 40 moves the card guide unit 20 in the direction of increasing/decreasing the intervals G1 and G2 between the magnetic head 10 and the magnetic card 100 when the insertion detecting unit 30 detects the insertion of the magnetic card 100.

Accordingly, a magnetic level detected by the magnetic head 10 increases in the state (interval G1) where the interval between the magnetic head 10 and the magnetic card 100 is narrow. This makes it easier to read even a demagnetized magnetic card 10 having a low magnetic level. In contrast, in the state (interval G2) where the above described interval is wide, a magnetic level detected by the magnetic head 10 decreases, making it possible to prevent an influence exerted by a distorting of magnetic data.

In the meantime, a complex control is needed to change a constant of a read circuit or to change a read sensitivity by increasing/decreasing the interval between the magnetic head 10 and the magnetic card 100 according to a type of the magnetic card 100 or a read state of magnetic data. In this embodiment, however, the guide unit driving unit 40 increases/decreases the intervals G1, G2 between the magnetic head 10 and the magnetic card 100 when the insertion detecting unit 30 detects the insertion of the magnetic card 100. Therefore, it becomes possible to implement the magnetic card reader apparatus 1 with a simple configuration.

Therefore, this embodiment is able to prevent a failure in reading the magnetic card 100 from occurring with a simple configuration.

Additionally, in this embodiment, the guide unit driving unit 40 moves the card guide unit 20 each time the insertion of the magnetic card 100 is detected. Accordingly, it becomes possible to prevent a failure in reading the magnetic card 100 from occurring with a simpler configuration.

Furthermore, in this embodiment, the guide unit driving unit 40 moves the card guide unit 20 between the first position P1 (interval G1) and the second position P2 (interval G2), where intervals between the magnetic head 10 and the magnetic card 100 are different from each other. Therefore, it becomes possible to prevent a failure in reading the magnetic card 100 from occurring with a simpler configuration.

Still further, in the modification example of this embodiment, illustrated in FIG. 4, the guide unit driving unit 40 moves the card guide unit 20 from the reference position P11 to either the position P13 at which the interval between the magnetic head 10 and the magnetic card 100 is wider than that at the reference position P11 or the position P12 at which this interval is narrow than the interval at the reference position P11, and the guide unit driving unit 40 moves the card guide unit 20 to the other position (position P12 or P13) when the next insertion of the magnetic card 100 is detected.

Accordingly, a position at which both a demagnetized magnetic card 100 and a magnetic card 100 having distorted magnetic data are easy to read is set as the reference position P11, thereby enabling magnetic data of a magnetic card 100 in which the magnetic data can be read at the reference position P11 to be immediately read. In contrast, for a magnetic card 100 having magnetic data that cannot be read at the reference position P11, it becomes easier to read the magnetic data as described above by moving the card guide unit 20 to increase/decrease the above described intervals. As a result, it becomes possible to further prevent a read failure from occurring.

Still further, in this embodiment, the insertion detecting unit 30 detects the insertion of the magnetic card 100 by making contact with the magnetic card 100. Accordingly, it becomes possible to move the card guide unit 20 with a simple control, thereby making it possible to prevent a failure in reading the magnetic card 100 from occurring with a simpler configuration.

Still further, in this embodiment, the card guide unit 20 guides the magnetic card 100 on both the right and the back sides of the magnetic card 100. However, the card guide unit 20 may be configured to guide the magnetic card 100 only on one of these sides. Also in this case, it is possible to increase/decrease the above described intervals by causing the guide unit driving unit 410 to move the card guide unit 20.

Still further, in this embodiment, the insertion detecting unit 30 is of a contact type for detecting the insertion of the magnetic card 100 by making contact with the magnetic card 100. Therefore, it becomes possible to implement the magnetic card reader apparatus 1 with a simpler configuration as described above. However, the insertion detecting unit 30 may be configured to detect the insertion of the magnetic card 100 by adopting, for example, a detecting unit of a non-contact type, such as an optical sensor or the like.

Still further, in this embodiment, the insertion detecting unit 30 is arranged on the side of the entry of the slit 51. However, the insertion detecting unit 30 may be arranged on the side of the exit of the slit 51. Namely, the insertion detecting unit 30 may be arranged at any position as long as it can detect the insertion of the magnetic card 100.

If the insertion detecting unit 30 is arranged on the entry side of the slit 51, the interval between the magnetic card 100 and the magnetic head 10 is increased/decreased immediately after the magnetic card 100 is inserted. In contrast, if the insertion detecting unit 30 is arranged on the exit side of the slit 51, the interval between the magnetic card 100 inserted next and the magnetic head 10 is increased/decreased.

### Different Embodiment

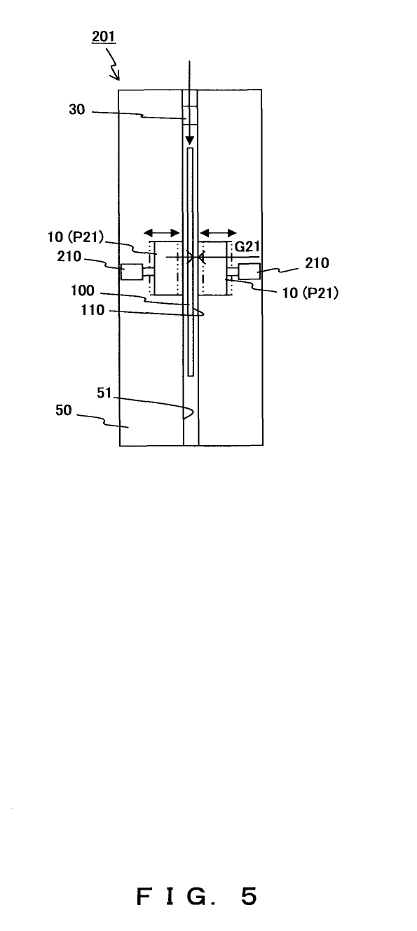

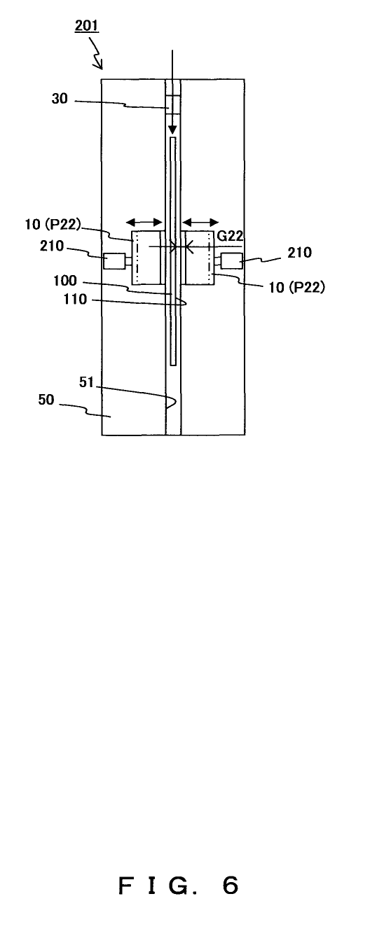

FIGS. 5 and 6 are perspective top views illustrating an internal structure of a magnetic card reader apparatus 201 according to a different embodiment of the present invention.

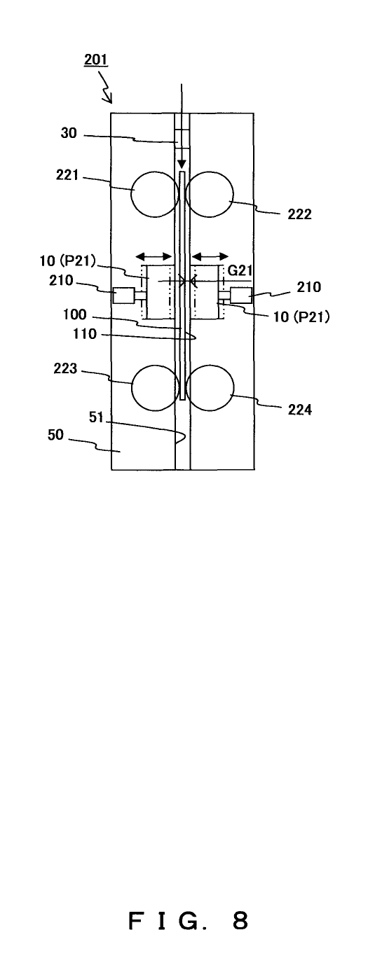

The magnetic card reader apparatus 201 according to this embodiment is almost the same as the magnetic card reader apparatus 1 according to the above described embodiment except that the interval increase/decrease driving unit for increasing/decreasing the interval between the magnetic head 10 and the magnetic card 100 is not the guide unit driving unit but a head driving unit (reading unit driving unit) 210 for moving the magnetic head (magnetic data reading unit) 10 and that the card guide unit is omitted (a card guide unit (guide members 221 to 224) is arranged in a modification example of FIG. 8). Accordingly, the same components are denoted with the same reference numerals, and their detailed descriptions are omitted.

The magnetic card reader apparatus 201 illustrated in FIGS. 5 and 6 includes two magnetic heads 10 and 10 as magnetic data reading units, an insertion detecting unit 30, a housing 50, and two head driving units 210 and 210 as reading unit driving units (interval increase/decrease driving units).

The head driving units 210 and 210 are, for example, a solenoid and a plunger similar to the guide unit driving unit 40 according to the above described embodiment. The head driving units 210 and 210 are provided within the housing 50.

The head driving units 210 and 210 respectively move the magnetic heads 10 and 10 between a first position P21 (see FIG. 5) and a second position P22 (see FIG. 6), at which intervals (G21 and G22) between the magnetic head 10 and the magnetic card 100 are different from each other, by pushing/pulling the magnetic heads 10 and 10 when the insertion detecting unit 30 detects an insertion of the magnetic card 100.

Since the magnetic stripe 110 of the magnetic card 100 is formed on the right side in FIG. 5, the interval G21 between the magnetic head 10 on the right side and the magnetic card 100 when the magnetic head 10 stays at the first position P21 as illustrated with a solid line in FIG. 5 is narrower than the interval G22 when the magnetic head 10 stays at the second position P22 illustrated with a solid line (double dotted dashed line in FIG. 5) in FIG. 6.

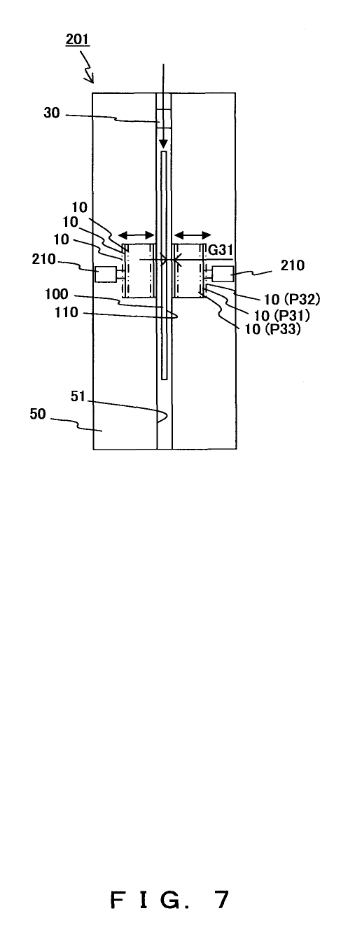

As illustrated in FIG. 7 (a first modification example of this embodiment), the magnetic heads 10 and 10 may be moved from a reference position P31 to either a position P32 at which an interval (G31) between the magnetic head 10 and the magnetic card 100 is wider than that at the reference position P31 or a position P33 at which the interval (G31) is narrow, and the magnetic heads 10 and 10 may be moved to the other position (position P33 or P32) when the next insertion of the magnetic card 100 is detected.

In this case, a control similar to that in the above described embodiment may be performed for the head driving units 210 and 210 so that magnetic data of the magnetic card 100, inserted after a predetermined amount of time elapses from the detection of the preceding insertion of the magnetic card 100, can be read with the magnetic head 10 staying at the reference position P31.

As illustrated in FIG. 8 (a second modification example of this embodiment), the guide members 221 to 224 may be arranged as the card guide unit for guiding the magnetic card 100. The guide members 221 to 224 according to this embodiment are secured to be immovable in the housing 50.

The four guide members 221 to 224 include the guide members 221 and 222 that face each other with the slit 51 interposed on the entry side (the upper side of FIGS. 5 and 6) of the slit 51, above the magnetic heads 10 and 10, and the guide members 223 and 224 that face each other with the slit 51 interposed on the exit side (the lower side of FIGS. 5 and 6) of the slit 51, below the magnetic heads 10 and 10.

The guide members 221 to 224 are, for example, rollers that are rotatable about a rotational axis extending in a vertical direction, and they guide the magnetic card 100 inserted in the slit 51.

Since the guide members 221 to 224 according to this embodiment are arranged in pairs so that the respectively paired guide members face each other, they can securely define an insertion route of the magnetic card 100. The insertion route of the magnetic card 100 passes through the middle of the slit 51 in the example illustrated in FIG. 8.

In the above described embodiment, each of the head driving units 210 moves the magnetic head 10 in the direction of increasing/decreasing the intervals G21 and G22 between the magnetic head 10 and the magnetic card 100 when the insertion detecting unit 30 detects the insertion of the magnetic card 100.

Accordingly, in the state (interval G21) where the interval between the magnetic head 10 and the magnetic card 100 is narrow, a magnetic level detected by the magnetic head 10 increases, making it easier to read even a demagnetized magnetic card 100 having a low magnetic level. In contrast, in the state (interval G22) where the above described interval is wide, a magnetic level detected by the magnetic head 10 decreases, making it possible to prevent an influence exerted by a distorting of magnetic data.

Additionally, the head driving units 210 and 210 increase/decrease the intervals G21 and G22 between the magnetic head 10 and the magnetic card 100 when the insertion detecting unit 30 detects the insertion of the magnetic card 100. Therefore, it becomes possible to implement the magnetic card reader apparatus 210 with a simple configuration.

Accordingly, also according to this embodiment, it becomes possible to prevent a failure in reading the magnetic card 100 from occurring with a simple configuration in a similar manner as in the above described embodiment.

Additionally, in this embodiment, each of the head driving units 210 moves the magnetic head 10 each time the insertion of the magnetic card 100 is detected. Therefore, it becomes possible to prevent a failure in reading the magnetic card 100 from occurring with a simpler configuration.

Furthermore, in this embodiment, each of the head driving units 210 moves the magnetic head 10 between the first position P21 (interval G21) and the second position P22 (interval G22), at which the intervals between the magnetic head 10 and the magnetic card 100 are different from each other. Therefore, it becomes possible to prevent a failure in reading the magnetic card 100 from occurring with a simpler configuration.

Furthermore, in the modification example of this embodiment, illustrated in FIG. 7, each of the head driving units 210 moves the magnetic head 10 from the reference position P31 to either the position P32 at which the interval between the magnetic head 10 and the magnetic card 100 is wider than that at the reference position P31 or the position P33 at which this interval is narrow than the interval at the reference position P31, and each of the head driving units 210 also moves the magnetic head 10 to the other position (position P32 or P33) when the next insertion of the magnetic card 100 is detected.

Accordingly, a position at which both a demagnetized magnetic card 100 and a magnetic card 100 having distorted magnetic data are easy to read is set as the reference position P31, thereby enabling magnetic data of a magnetic card 100 in which the magnetic data can be read at the reference position to be immediately read. In contrast, for a magnetic card 100 having magnetic data that cannot be read at the reference position P31, it becomes easier to read the magnetic data as described above by moving the magnetic head 10 to increase/decrease the above described intervals. As a result, it becomes possible to further prevent a read failure from occurring.

Additionally, also in this embodiment, the insertion detecting unit 30 detects the insertion of the magnetic card 100 by making contact with the magnetic card 100. Accordingly, it becomes possible to move the magnetic heads 10 and 10 with a simple control, thereby enabling the magnetic card reader apparatus 201 to be implemented with a simpler configuration.

Furthermore, in this embodiment, the magnetic card reader apparatus 201 includes the card guide unit (the guide members 221 to 224) for guiding the magnetic card 100. Accordingly, it becomes possible to stabilize the interval between the magnetic head 10 and the magnetic card 100 by guiding the magnetic card 100 with the guide members 221 to 224. As a result, it becomes possible to further prevent a failure in reading the magnetic card 100 from occurring.

In this embodiment, the two magnetic heads 10 and 10 and the two head driving units 210 and 210 are arranged to face each other with the slit 51 interposed. This enables magnetic data to be read from the magnetic stripe 110 of the magnetic card 100 regardless of the orientations of the right and the back sides of the magnetic card 100 when the magnetic card 100 is inserted. Therefore, if the orientations of the right and the back sides of the magnetic card 100 are limited to either of these orientations, only one magnetic head 10 and one head driving unit 210 may be provided.

What is claimed is:

1. A magnetic card reader apparatus, comprising:
a magnetic data reading unit configured to read magnetic data of a magnetic card;
an insertion detecting unit configured to detect an insertion of the magnetic card; and
an interval increase/decrease driving unit configured to increase/decrease an interval between the magnetic data reading unit and the magnetic card when the insertion detecting unit detects the insertion of the magnetic card.

2. The magnetic card reader apparatus according to claim 1, further comprising
a card guide unit configured to guide the magnetic card, wherein
the interval increase/decrease driving unit is a guide unit driving unit configured to increase/decrease the interval between the magnetic data reading unit and the magnetic card by moving the card guide unit.

3. The magnetic card reader apparatus according to claim 2, wherein
the guide unit driving unit moves the card guide unit each time the insertion of the magnetic card is detected.

4. The magnetic card reader apparatus according to claim 2, wherein
the guide unit driving unit moves the card guide unit between first and second positions, at which intervals between the magnetic data reading unit and the magnetic card are different from each other.

5. The magnetic card reader apparatus according to claim 2, wherein
the guide unit driving unit moves the card guide unit from a reference position to one of a position at which the interval between the magnetic data reading unit and the magnetic card is wider than the interval at the reference position, and a position at which the interval is narrow than the interval at the reference position, and the guide unit driving unit moves the card guide unit to the other position when a next insertion of the magnetic card is detected.

6. The magnetic card reader apparatus according to claim 1, wherein
the interval increase/decrease driving unit is a reading unit driving unit configured to increase/decrease the interval between the magnetic data reading unit and the magnetic card by moving the magnetic data reading unit.

7. The magnetic card reader apparatus according to claim 6, wherein
the reading unit driving unit moves the magnetic data reading unit each time the insertion of the magnetic card is detected.

8. The magnetic card reader apparatus according to claim 6, wherein
the reading unit driving unit moves the magnetic data reading unit between first and second positions, at which intervals between the magnetic data reading unit and the magnetic card are different from each other.

9. The magnetic card reader apparatus according to claim 6, wherein
the reading unit driving unit moves the magnetic data reading unit from a reference position to one of a position at which the interval between the magnetic data reading unit and the magnetic card is wider than the interval at the reference position, and a position at which the interval is narrow than the interval at the reference position, and the reading unit driving unit moves the magnetic data reading unit to the other position when a next insertion of the magnetic card is detected.
